(19) United States
(12) Patent Application Publication
(10) Pub. No.: US 2025/0224943 A1
(43) Pub. Date: Jul. 10, 2025

(54) Efficient Build Procedures for Application Source Code

(71) Applicant: ServiceNow, Inc., Santa Clara, CA (US)

(72) Inventors: Bora Yuksel, San Diego, CA (US); Wolfgang David Wedemeyer, San Diego, CA (US)

(21) Appl. No.: 18/404,669

(22) Filed: Jan. 4, 2024

(51) Int. Cl. G06F 8/41

(52) U.S. Cl. CPC G06F 8/48; G06F 8/427

(57) ABSTRACT

An embodiment may involve obtaining a representation of portions of source code and the portions of the source code may be associated with a component of a software application, generating a code string based on the representation of portions of the source code, generating a hash digest based upon the code string, determining, based on the hash digest and a previous hash digest, that the portions of the source code satisfy a change condition, and in response to determining that the change condition is satisfied, updating the component of the software application in relation to the portions of the source code.

### BACKGROUND

A computing platform may be large and complex, simultaneously supporting hundreds or thousands of software applications, as well as higher-level services facilitated by groups of software applications operating in conjunction with one another. In the course of creating these software applications, their source code may become lengthy and difficult to understand, even for an experienced programmer. For example, a single source code file may include the code for hundreds of components of an application.

The longer and more complex the source code in a source code file, the longer it will generally take for the code to compile and build. More build time thus also consumes more compute resources that may be better used for other purposes. Notably, any changes to the code require the compiling and building of the entire source code file.

### SUMMARY

Various implementations disclosed herein overcome these and possibly other technical problems by providing techniques for autonomously analyzing source code to determine changes within specific components therein. To do so, the implementations introduce a method for identifying a scoped variable identifier, or SVI, within a block of code associated with a specific element of an application. Then, the relevant code is converted to a syntax tree, a string representation of which is then hashed and then compared to past versions to determine if a change to that block of code has occurred.

This approach results in fewer errors when making changes to the code of an application. Additionally, this approach may prevent inadvertent loss of information due to a variable changing that was previously unable to be detected without the implementation disclosed herein.

Moreover, this approach allows for application components to be updated while deployed, known as “hot module replacement.” By identifying which variables have changed, the system can detect whether the state will be maintained if the code changes are compiled and the updated application component built, or if a variable is changed so that the state is not maintained and any stored information will be lost if the component were to be compiled and rebuilt again.

Given that the build process can take a long time, especially if the source code is lengthy and complex, these techniques reduce the build time and the amount of compute resources used.

Accordingly, a first example embodiment may involve obtaining a representation of portions of source code, wherein the portions of the source code are associated with a component of a software application. The first example embodiment may also involve generating a code string based on the representation of portions of the source code. The first example embodiment may also involve generating a hash digest based upon the code string. The first example embodiment may also involve determining, based on the hash digest and a previous hash digest, that the portions of the source code satisfy a change condition. The first example embodiment may also involve in response to determining that the change condition is satisfied, updating the component of the software application in relation to the portions of the source code.

A second example embodiment may involve a computing system that may include at least one processor, as well as memory and program instructions. The program instructions may be stored in the memory, and upon execution by the at least one processor, cause the computing system to perform operations in accordance with the first embodiment.

A third example embodiment may involve a non-transitory computer-readable medium, having stored thereon program instructions that, upon execution by a computing system, cause the computing system to perform operations in accordance with the first example embodiment.

A fourth example embodiment may involve a system that may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts source code for an application intended to run on a remote network management platform, in accordance with example embodiments.

FIG. 7 depicts a syntax tree constructed from source code, in accordance with example embodiments.

FIG. 8A depicts an overview of transforming source code into a text string, in accordance with example embodiments.

FIG. 8B depicts an overview of generating a hash digest from a text string, in accordance with example embodiments.

FIG. 9 depicts a hash table, in accordance with example embodiments.

FIG. 10 depicts a logic flow for updating a hash table, in accordance with example embodiments.

FIG. 11 depicts a high-level overview of selective rebuilding of source code components, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

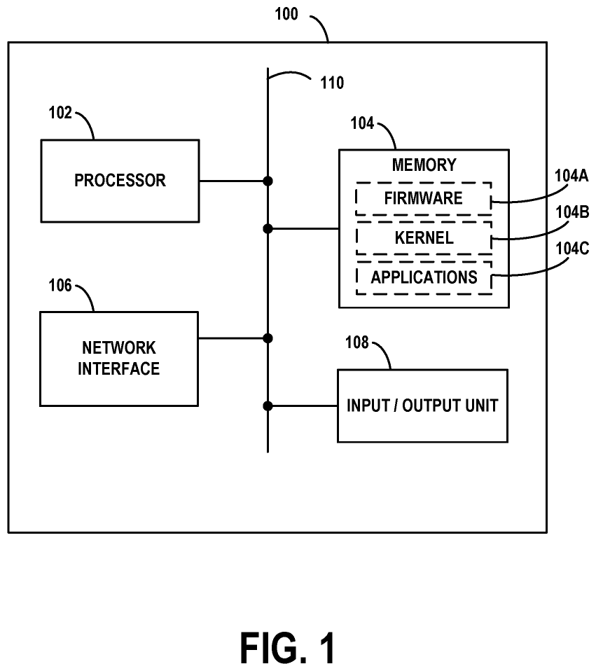

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

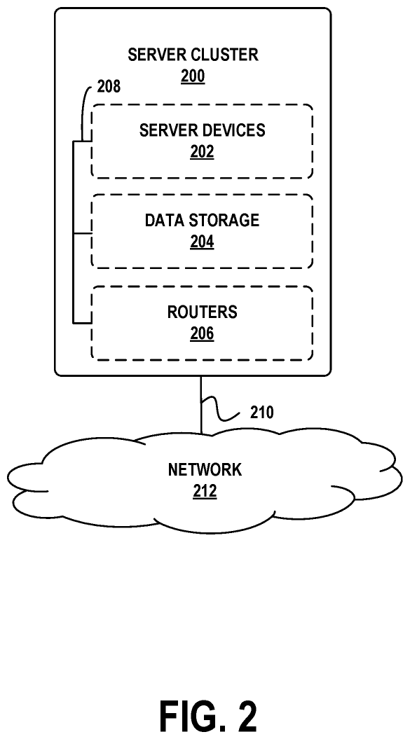

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

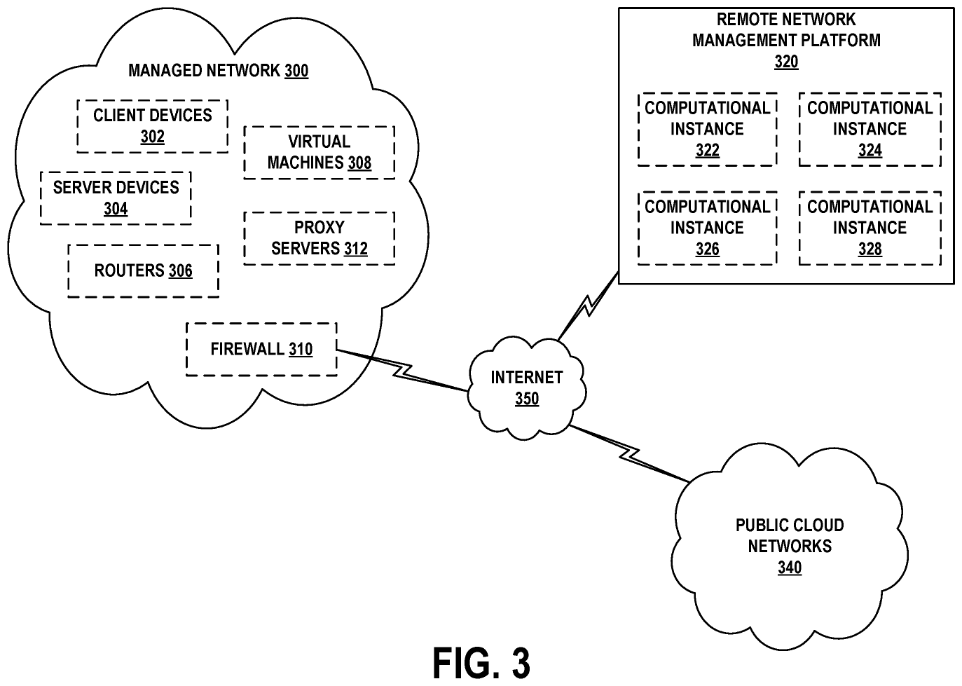

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include

Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

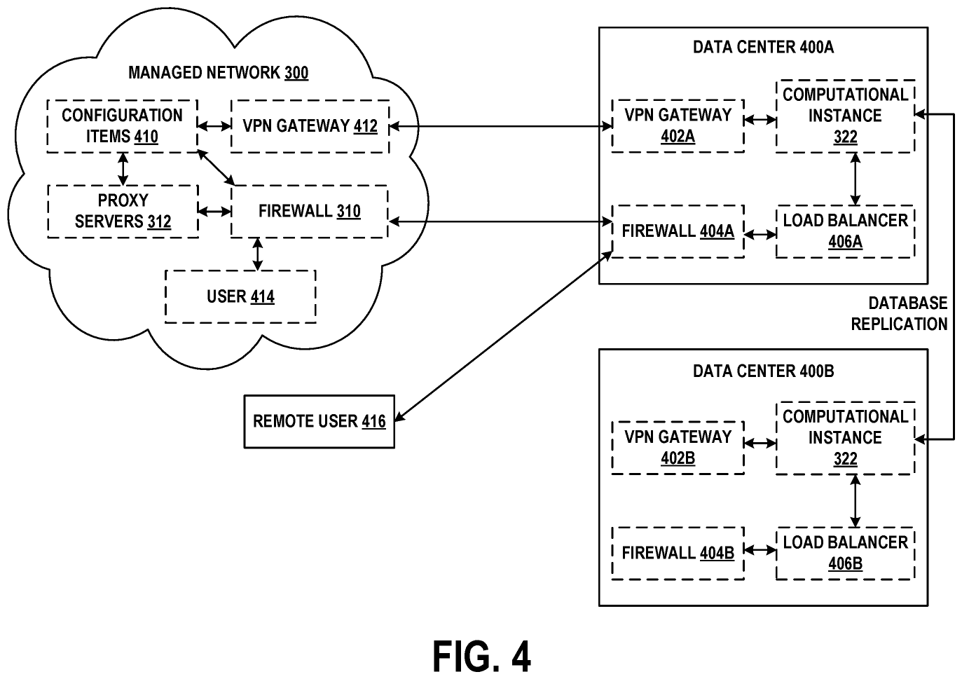

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

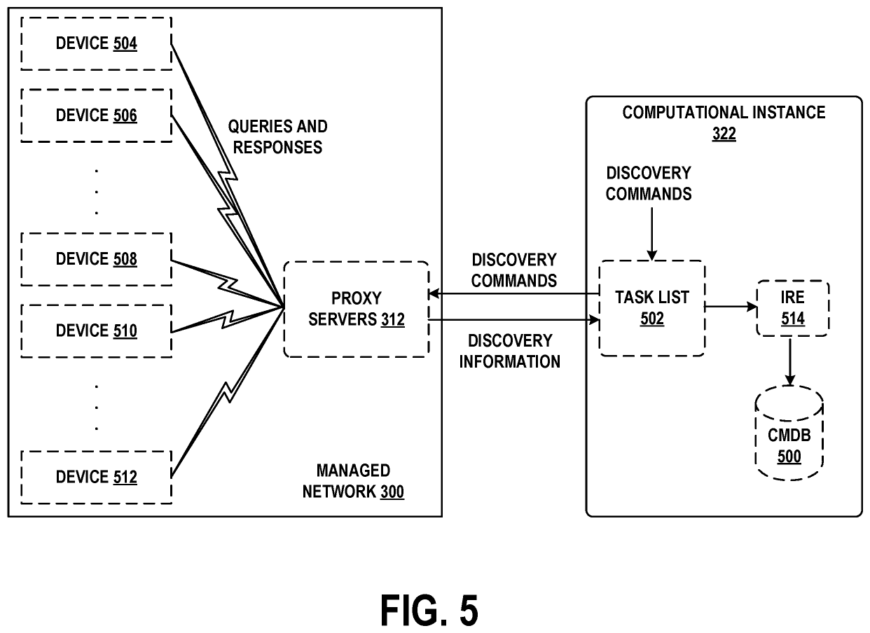

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Creating Applications for the Remote Network Management Platform

The foregoing sections of this disclosure have described some embodiments of a remote network management platform and provided examples of processes that may be performed in relation to a remote network management platform; for example, discovery and operations relating to configuration items.

As stated previously, a remote network management platform may include one or more computational instances which allow an application to be deployed on them for use by end users. In some embodiments, a remote network management platform may include features to allow users to create applications for eventual deployment on a remote network management platform.

As also noted previously, application source code may become lengthy and complex, which in turn increases the amount of time required for the source code to build into the deployable application. In the context of this disclosure, “build” and “build process” refer to the actions required to change application source code into a deployable application (e.g., compiling the source code to object code or machine-executable instructions).

Additionally, as the application source code file grows in size and complexity, even an experienced programmer may have trouble keeping track of all the changes made to a source code file. While modern computing systems are able to determine whether or not a whole file has been changed, there exists no process for identifying whether a subset of code relating to a specific variable or other code element has been changed.

Thus, it would be desirable if a process existed to cut down on the time required to build large and complex application source code files, thus saving compute resources that may be better allocated for other tasks, as well as providing the ability to identify changes to specific code elements in order to determine how specific components of the deployed application may be impacted by the changes to the code.

Accordingly, features of the present disclosure can help to address these and other issues to provide an improvement to select technical fields. Specifically, features of the present disclosure allow for faster and more efficient parsing of source code as well as identifying changes to specific components of a deployed application based on changes to specific elements within the source code.

Within a source code file, there may be different variables that exist within different scopes. A variable, as used within this disclosure, refers to a value within code that can vary, hence the name. Scope, on the other hand, refers to the part of the code in which a specific variable can be used. An identifier may be a reference to an already existing variable or function. Putting these three terms together, a scoped variable identifier, or SVI, is another way to express a specific scope within a source code file with reference to a specific variable or function. An SVI may relate to a specific component of an application, or may contain more general information relating to the overall functioning of the application as a whole. Since an SVI is within or refers to a certain scope, it is not at the top level of the source code.

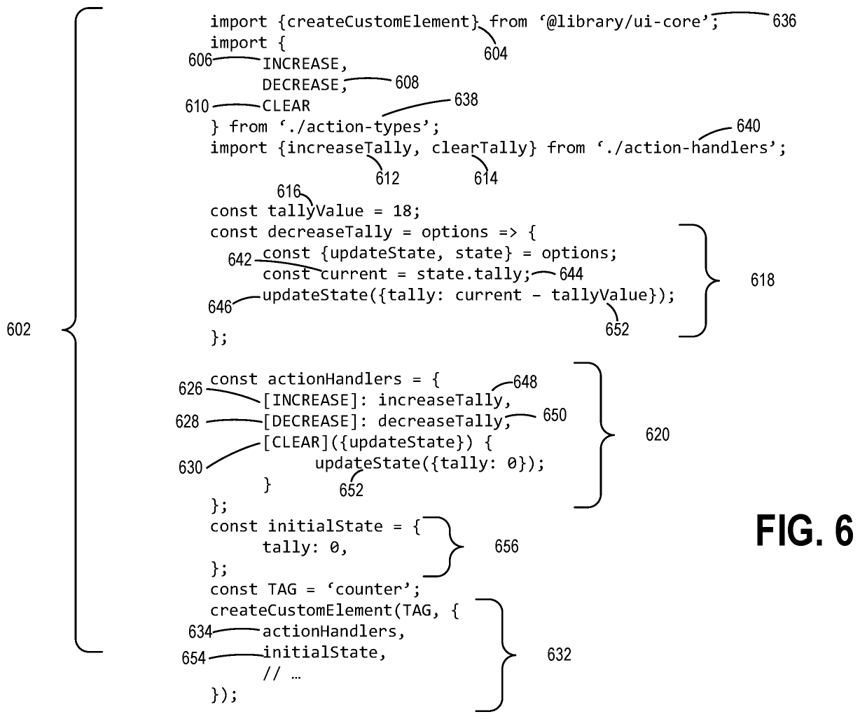

In some embodiments, the application configured to execute on a remote network management platform may include source code as depicted in FIG. 6. While FIG. 6 depicts JavaScript source code by way of example, other programming languages may be used to construct applications.

The example illustrated in FIG. 6 contains several code elements, including declarations and definitions of functions and variables. Within a software context, the “declaration” of a function or variable simply means to assign a name and type to it and thus create a reference to it within a specific scope. On the other hand, the “definition” of a function or variable refers to giving it characteristics, such as assigning it a value or adding code to the function that performs certain tasks. In some programming languages, defining a function or variable also involves allocating system memory to store that function or variable.

Several examples of code elements are present in FIG. 6 as part of the file scope 602. The file imports (or includes for use) createCustomElement 604 from the ui-core library 636. When a function is imported from a library, its definition is thus in another file and thus need not be reproduced within the scope. Following this, createCustomElement 604 may be thought of as the declaration of createCustomElement for use within the file scope 602.

Also imported into the file scope 602 are the declarations INCREASE 606, DECREASE 608, and CLEAR 610, all of which may be assigned different values at a later point in the code. These specific variables are imported from the action-types library 638. Additionally, the source code file imports increaseTally 612 and clearTally 614 from the action-handlers library 640.

In some instances, the declaration and definition of a function or variable may occur in the same line of code, and one such example of this in FIG. 6 is the variable tally Value 616. It is declared with the type “const” (meaning it is a constant and cannot be changed while the program is executing) and the name “tally Value.” In the same line, it is defined to have the value 18.

Another declaration and definition occurs in FIG. 6—that of the decreaseTally function 618. This is also declared as a constant, and is defined to contain several other code elements or identifiers of such. For example, the decreaseTally function 618 declares and defines its own variables current 642, tally 644, and the function updateState 646, which changes the value of tally 644 to the difference of current 642 and the tally Value identifier 652, which refers back to the tally Value variable 616.

Further examples in FIG. 6 illustrate how code elements refer and relate to one another to perform tasks. The actionHandlers function 620 builds on several other code elements either imported or declared and defined previously in the code. For example, actionHandlers 620 is declared as a “const,” and sets INCREASE 626 (referring to the INCREASE 606 imported from action-types 638) to include increaseTally 648 (referring to the imported increaseTally 612 imported from action-handlers 640).

The actionHandlers function 620 further sets DECREASE 628 (referring to the DECREASE 608 imported from action-types 638) to include a decreaseTally identifier 650, which refers to the decreaseTally function 618 defined earlier within the file scope 602.

Additionally, the actionHandlers function 620 sets CLEAR 630 to refer to updateState 652, which then further refers to the updateState function 646 defined within decrease Tally 618).

Other variables may also be set. In FIG. 6, the const initialState function 656 sets the value of “tally” to zero.

The last few elements within the file scope 602 are function calls, which “call” a function to perform its action by giving it certain values, which may be variables or even other functions in some embodiments. Illustrated in FIG. 6 is the createCustomElement function call 632, which “calls upon” the imported function createCustomElement 604 from the ui-core library 636. The program “passes,” or gives, values to the function. In this example, an actionHandlers identifier 634 is passed to the createCustomElement function call 632. Accordingly, the actionHandlers identifier 634 refers to the actionHandlers function 620 defined earlier within the file scope 602. Notably, the actionHandlers identifier 634 is an SVI. The createCustomElement function may in some embodiments have multiple identifiers passed to it. For example, the initialState identifier 654, referring to the initialState function 656, is also passed to createCustomElement in FIG. 6.

The overall structure of the example in FIG. 6 is as follows: the program wishes to perform an increase, decrease, and clear action within the application, and thus imports those from the action-types library 638. Then, in order so those actions may actually do something, action handlers are implemented, either imported from the action-handlers library 640 or defined as with decreaseTally 618. The actions are linked to their respective action handlers within the actionHandlers function 620, which is included within the createCustomElement call in order to place the functionality in the application. Thus, for example, when “increase” is pressed, the tally will increase, and vice versa for the other actions, setting off a chain of related operations between functions, variables, and other code elements.

One purpose of the example of FIG. 6 is to illustrate that even a seemingly simple computer program or application may actually be rather complex, with many interrelations between functions, variables, and other code elements that make it difficult for even a seasoned programmer to identify what will be different in the application after a change to the source code is made. Thus, this disclosure will present a solution to identifying those code changes. However, a description of how the source code becomes a deployable application will be useful to understanding some embodiments of the current disclosure.

Once a developer is satisfied with the source code of an application, the code would go through a build process to become the deployable application. The build process may in some embodiments occur automatically once the source code file is saved.

### VII. Constructing and Analyzing a Syntax Tree for Detecting Code Changes

### A. Syntax Tree Structure

In some embodiments, the start of the build process for a source code file may also simultaneously begin a process to identify changes within a specific SVI. If a code change is identified in a specific SVI, it can be determined if a component of the built and deployed application is affected by the code change in question.

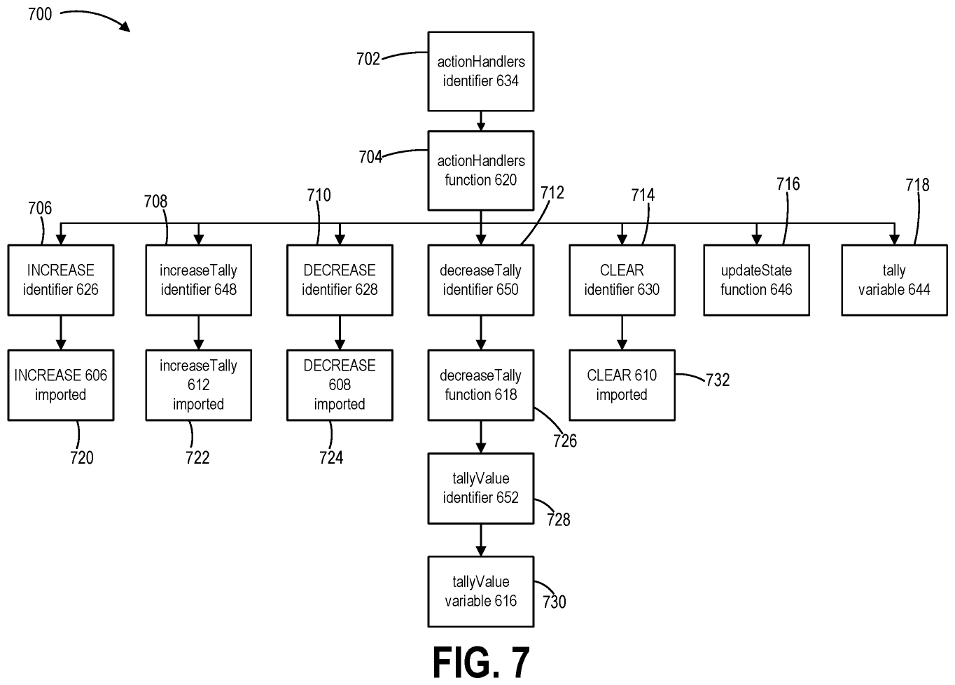

To accomplish this, some embodiments may construct a syntax tree of the SVI to identify the code elements within it. An example of such a syntax tree is illustrated in FIG. 7.

The syntax tree 700 in FIG. 7 represents a syntax tree of the actionHandlers identifier 634 that was passed to the createCustomElement function call 632 previously discussed above. While actionHandlers is used as an example, the same representation and further operations may be performed for other SVIs, for example initialState 654 in FIG. 6. At the time a build process is executed, the system may parse through the different variables and other code elements within the specified SVI to identify the elements and the relationships to one another. In some embodiments, other identifiers may be passed as parameters to the createCustomElement function call 632, and also have the process herein described performed in relation to them. Such identifiers may also be referred to as indicators, as they indicate a specific portion of the source code.

For example, the “root” or source of the syntax tree 700 is the actionHandlers identifier node 702, which refers to actionHandlers identifier 634 that was passed to the createCustomElement function call 632. This actionHandlers identifier node in turn refers to the actionHandlers function node 704. This is the representation of the actionHandlers function 620 within the syntax tree.

From the actionHandlers function node 704, the tree branches out to parse each code element referred to within the function, and searches for the corresponding elements within the overall scope specified and further determine which elements depend on each other. In the example embodiment illustrated in FIG. 7, the overall scope is the code file in FIG. 6. There are seven unique code elements referred to within the actionHandlers function 602, and thus branch off the actionHandlers function node 704 within the tree. Nodes in the syntax tree 700s are connected via links, which represent a reference or dependency within the code from one node to another.

The INCREASE node 706 represents the INCREASE identifier 626 within the source code, which in turn refers to INCREASE 606 imported from the action-types library 638. To represent the importation from the library, the INCREASE import node 720 is part of the syntax tree and connects to the INCREASE node 706.

The increaseTally node 708 represents the increaseTally identifier 648 within the source code, which in turn refers to increaseTally 612 imported from the action-handlers library 640. To represent the importation from the library, the increase Tally import node 722 is part of the syntax tree and connects to the increaseTally node 708.

The DECREASE node 710 represents DECREASE 628, which in turn refers to DECREASE 608 imported from the action-types library 638. To represent the importation from the library, the DECREASE import node 724 is part of the syntax tree and connects to the DECREASE node 710.

The decreaseTally node 712 represents the decreaseTally identifier 650 within the source code, which in turn refers to the decreaseTally function 618 defined earlier in the source code. This reference is represented in the syntax tree by the decrease Tally function node 726. As the decreaseTally function 618 also involves the tally Value identifier 652, it is represented in the syntax tree by the tally Value identifier node 728. As the tally Value identifier 652 refers back to the tally Value variable 616, that too is represented in the syntax tree by the tally Value variable node 730.

The CLEAR node 714 represents the CLEAR identifier 630, which in turn refers to CLEAR 610 imported from the action-types library 638. To represent the importation from the library, the CLEAR import node 732 is part of the syntax tree and connects to the CLEAR node 714.

The updateState node 716 represents the updateState function 646. The tally node 718 represents the tally variable 644.

### B. Traversing the Tree and Creating a String

In order to identify changes to specific parts of the source code, the next step in the process is to traverse the created syntax tree, which means to “step through” some or all the elements of the tree in a certain order or pattern. Several different methods of traversing a tree data may be used in some embodiments, including a breadth-first search and a depth-first search. In the embodiments described herein, a breadth-first search is used by way of example.

A breadth-first search is a method for traversing a tree that first checks all nodes at a specific “depth” before moving to a lower depth in the tree. For example, a breadth-first search performed on the syntax tree illustrated in FIG. 7 would first traverse nodes 702 and 704 before going on to 706 and then to 708 and so on. Once node 718 has been traversed in this manner, the search would then traverse node 720 and then to 722, and so on. This process is repeated for each depth level of the tree until every node has been visited.

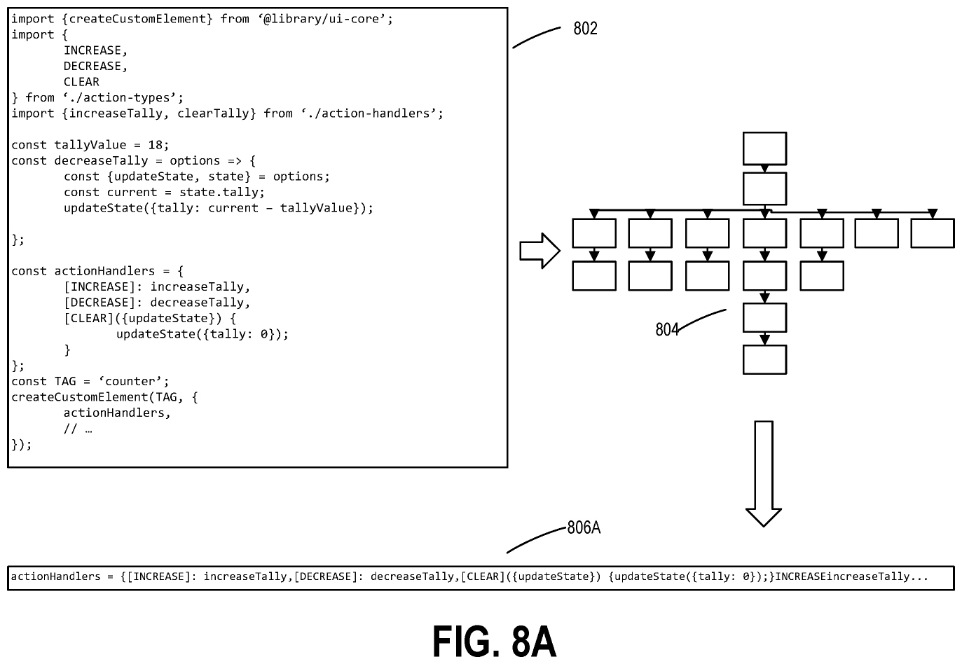

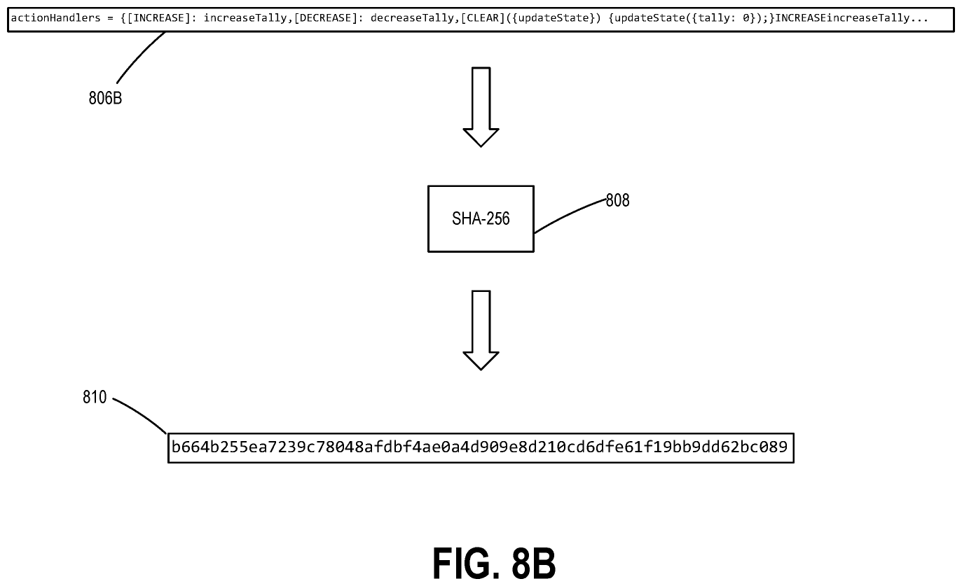

While traversing the tree using a traversal method as described above, the method may append the code related to each element of the tree to a single text string, such that all the code relating to the elements described in the tree is concatenated (joined) together, rather than in separate lines and statements as in the original source code. A high-level overview of this process, going from code to syntax tree to text string, is illustrated in FIG. 8A.

FIG. 8A depicts source code 802 being transformed first into a syntax tree 804, according to the process described above. Then, a string 806A is created by traversing the syntax tree.

In the string, the “root” node is added to the string first. This is represented with actionHandlers in the string 806A. Then, as the tree is traversed, the additional elements of the syntax tree 804 are appended onto the string, with INCREASE, DECREASE, and so on, as also depicted in string 806A. Once every node in the tree has been visited and its content appended to the string, the method moves onto the hashing step.

### C. Hashing the String

Once the string containing all the code relating to the elements of the syntax tree is generated, a hash value may be generated from the string. Hashing, using an algorithm such as Secure Hash Algorithm 2 with a 256-bit digest (SHA-256), creates a fixed-length numerical value, or digest, from a string of data. Other hash algorithms may be used in other example embodiments.

The advantage of using a hash algorithm for the purpose of identifying changes to code is twofold. The first advantage is that the same source data will always generate the same digest. The second advantage is that even the smallest change to the source data results in a digest that is different and distinct from the digest generated from the original data. Thus, in order to detect changes, all that would be necessary would be to determine if the digests differ. Such a difference would mean that the source data, in this example the source code, also differs from each other.

This hashing process is illustrated as an example in FIG. 8B, using a SHA-256 algorithm. The string produced from the syntax tree in FIG. 8A is depicted in FIG. 8B as string 806B, which is then passed through the SHA-256 algorithm 808. This algorithm then produces the digest 810, which is depicted in hexadecimal notation for ease of display in the figures. Digests may be displayed in other notations in other embodiments.

### D. Mapping the Hashed Value and Making Comparisons

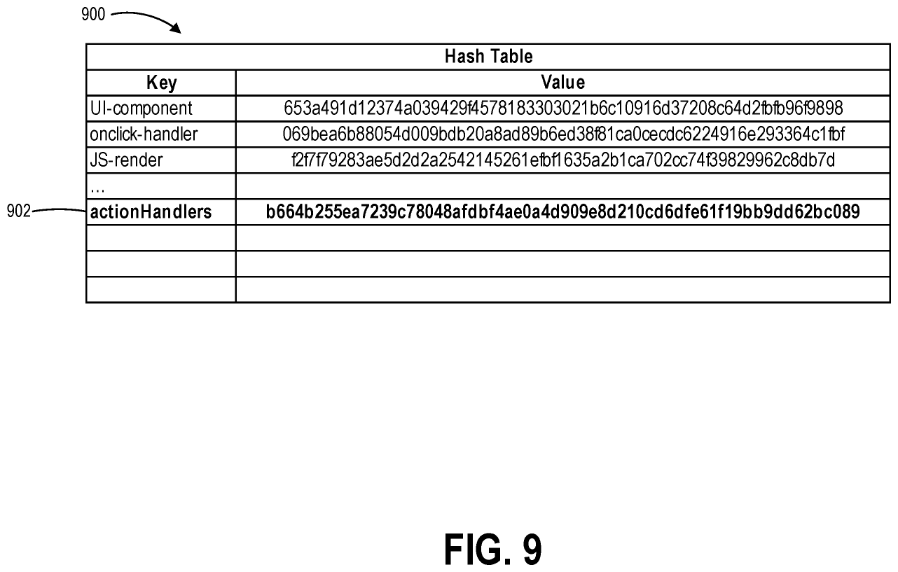

Once a digest is generated for the string, it may be entered into a hash table 900 as illustrated in FIG. 9. A hash table is a data structure that stores information in the form of key-value pairs, with unique values per key. The generated digest from the code string related to an SVI is entered into the hash table with the name as the key. For example, in FIG. 9, the generated hash value for the example code in FIG. 6 would be entered into the hash table 900 with the key “actionHandlers” in row 902. Emphasis has additionally been added to distinguish the actionHandlers value from other example values that may be in the hash table 900.

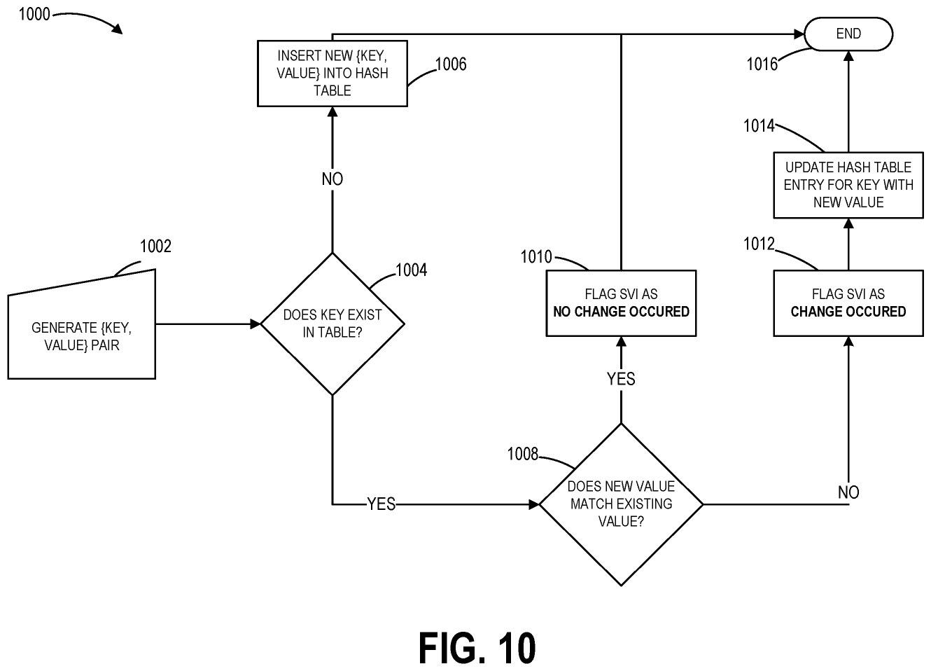

If a value already exists for that key within the hash table, then a comparison may be made. If the new value differs from the existing value, then that means that the code used to generate those values are different, and thus a change was made in the code related to that specific SVI. This hash table logic flow 1000 is illustrated in FIG. 10.

Block 1002 may involve generating a key-value pair of the form {key, value}, where the key may be the SVI that is desired to detect changes in, while the value may be the hash algorithm digest of the code string generated according to the process involving a syntax tree described in this disclosure and illustrated at a high level in FIGS. 8A and 8B. The logic flow may then proceed to block 1004.

Block 1004 may involve checking whether the key already exists in the hash table. If the key does not exist in the hash table, the logic flow may proceed to block 1006. If the key does exist in the hash table, the logic flow may proceed to block 1008.

Block 1006 may involve inserting the key-value pair into the hash table. The logic flow may then proceed to the end state block 1016.

Block 1008 may involve comparing the new value to the existing value in the hash table. If the values match, then the logic flow may proceed to block 1010. If the values do not match, then the logic flow may proceed to block 1012.

Block 1010 may involve communicating that no change has occurred in the source code within the specified SVI. This may be in the form of a flag or other notification. The logic flow may then proceed directly to the end state block 1016.

Block 1012 may involve communicating that a change has occurred in the source code within the specified SVI. This may be in the form of a flag or other notification. The logic flow may then proceed to block 1014.

Block 1014 may involve updating the hash table entry with the specified key with the new value, overwriting the previous value. The logic flow may then proceed to the end state block 1016.

Block 1016 represents the end state for the logic flow of FIG. 10. A new logic flow may begin after the logic flow has reached this state.

### VIII. Example Applications

### A. Selective Rebuilding of Source Code

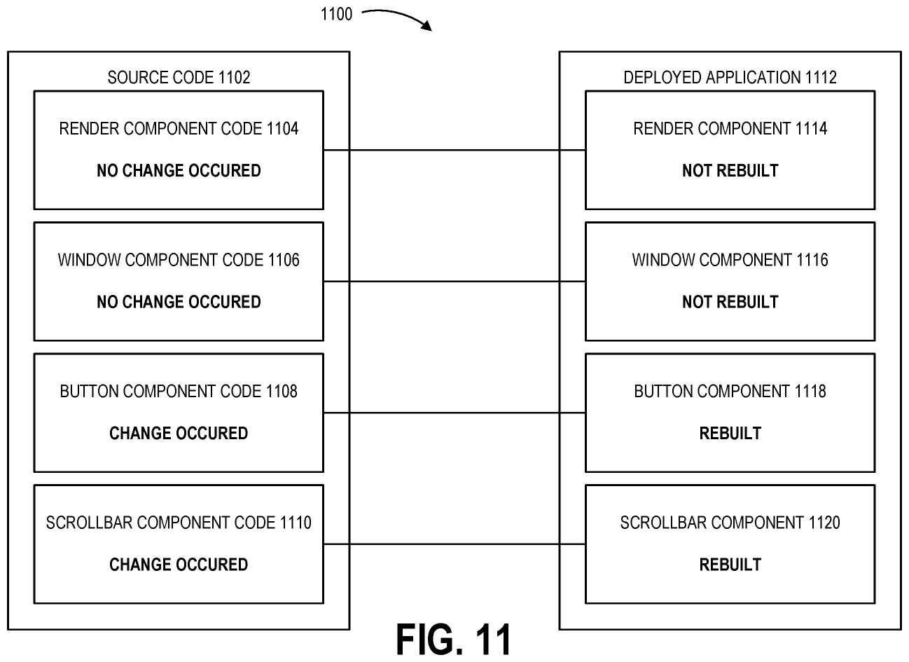

One application of the above process is providing a system with the ability to only rebuild portions of the source code that have been identified as being changed. An example of this is illustrated in FIG. 11.

FIG. 11 depicts a high-level overview of the relationship between the source code 1102 for an UI application 1100 and the components of the deployed application 1112. For example, the source code may contain render component code 1104, window component code 1106, button component code 1108, and scrollbar component code 1110. This code may respectively be the source code for different components of the deployed application 1112, such as a render component 1114, a window component 1116, a button component 1118, and a scrollbar component 1120.

In the example, the above process as well as the logic flow of FIG. 10 has been run on the SVIs of each of the four components of the source code 1102, and the results have been illustrated in FIG. 11. The render component code 1104 and window component code 1106 have had no changes detected, while changes have been detected in button component code 1108 and scrollbar component code 1110.

Accordingly, the embodiments of the present disclosure allow only the changed components of application 1100 to be rebuilt. As illustrated in FIG. 11, only the button component 1118 and scrollbar component 1120 have been rebuilt.

This improvement saves build time by only rebuilding changed components. In large and complex source code, this could save a large amount of build time and thus compute resources as well.

### B. Hot Module Replacement

Another, more specific application of the process described above using a syntax tree to identify source code changes is for hot module replacement (HMR) within applications actively executing on a remote network management platform. HMR generally refers to the replacement (whether that be updating, removing, or otherwise changing) a module within a executing program without significant disruption to the end-user.

Some features of the present disclosure allow for HMR to be performed. To use the example of FIG. 6, the code may described an interactive web application that allows a user to increment, decrement, or reset a tally. The current value of the tally is stored in the current 642 and tally 644 variables declared and defined within the decrease Tally function 618. Generally, if a change is made to the source code of a web application, the entire webpage must be reloaded so that the changes are reflected for the end user. This results in the webpage losing any state information or stored data.

Additionally, some web applications may be extremely large and complex, and thus rebuilding and loading the webpage may take a long time (e.g., 5-30 seconds or more). This greatly affects the user experience, and harms developers' efforts to test changes to their code if a minor change results in 30 seconds of waiting (for example).

However, by identifying what SVIs have code changes, a remote network management platform may be able to determine which components of the application need be updated, and determine whether the entire webpage should be reloaded, or if only a specific set of components should be reloaded. To continue with the example of FIG. 6, initialState 654 may also have its own tree built and changes detected. If a code change is made to initialState that affects the value of tally (for example, changing the value tally from 0 to 1), then that will necessarily affect the stored value of the variable tally 644, and thus the page must be reloaded and the value within tally 644 lost.

If, however, the code change is made to a different part of the code that is not relevant to the value of tally 644, then only that component of the application may be updated, maintaining the state information and ensuring that the stored data is not lost as it would be on a full reload. Thus, the webpage is updated without the loss of entered information.

### IX. Example Technical Improvements

These embodiments provide a technical solution to a technical problem. One technical problem being solved is long build times for applications. In practice, this is problematic because it greatly increases the downtime of an application as it must wait for the build process to be complete before it can be deployed. As noted above, not every component of an application may be affected by a code change, and thus only rebuilding and reloading components when necessary may avoid waiting for a more extensive or full build that was caused by a minor change to the source code. This is also a problem as it wastes valuable computing resources, whether it be processing power or system memory usage

In the prior art, detection of code changes was only possible at the file level. Thus, these techniques do not permit the specificity of detecting what specific part of a program has changes pending that the present disclosure allows. The, prior art techniques did little if anything to address the difficult process of determining whether code has changed and what, if anything, may be affected by it.

The embodiments herein overcome these limitations by facilitating the detection of changes within specific areas of source code and thereby specific components of an application. In this manner, building applications for deployment can be accomplished in a more accurate and robust fashion. This results in several advantages, including a reduction in build time and less unnecessary usage of computing resources.

Other technical improvements may also flow from these embodiments, and other technical problems may be solved. Thus, this statement of technical improvements is not limiting and instead constitutes examples of advantages that can be realized from the embodiments.

### X. Example Operations

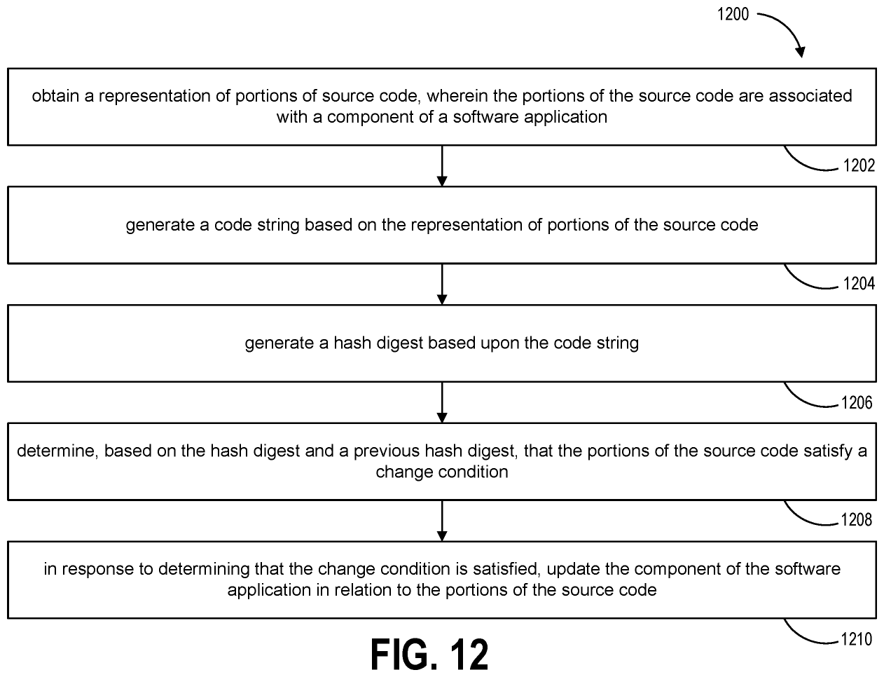

FIG. 12 is a flow chart 1200 illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1202 may involve obtaining a representation of portions of source code, wherein the portions of the source code are associated with a component of a software application.

Block 1204 may involve generating a code string based on the representation of portions of the source code.

Block 1206 may involve generating a hash digest based upon the code string.

Block 1208 may involve determining, based on the hash digest and a previous hash digest, that the portions of the source code satisfy a change condition.

Block 1210 may involve in response to determining that the change condition is satisfied, updating the component of the software application in relation to the portions of the source code.

In some embodiments, the process may further involve obtaining a further representation of further portions of the source code, wherein the further portions of the source code are associated with a further component of the software application, generating a further code string based on the further representation of the further portions of the source code, generating a further hash digest based upon the further code string, determining, based on the further hash digest and a further previous hash digest, that the further portions of the source code satisfy the change condition, and in response to determining that the change condition is satisfied, updating the further component of the software application in relation to the further portions of the source code.

In some embodiments, the process may further involve obtaining a further representation of further portions of the source code, wherein the further portions of the source code are associated with a further component of the software application, generating a further code string based on the further representation of the further portions of the source code, generating a further hash digest based upon the further code string, determining, based on the further hash digest and a further previous hash digest, that the further portions of the source code do not satisfy the change condition, and in response to determining that the change condition is not satisfied, refraining from updating the further component of the software application in relation to the further portions of the source code.

In some embodiments, the source code may contain further portions that are not associated with the component, and wherein any components of the software application related to the further portions are not updated in response to determining that the change condition is satisfied.

In some embodiments, the portions of the source code may be within one of a plurality of predefined portions of the source code, and obtaining the representation of the portions of the source code may involve selecting, from a set of indicators relating to the predefined portions of the source code, a specific indicator associated with the portions of the source code, and based on the specific indicator, parsing the source code to find the portions of the source code.

In some embodiments, the indicators may be parameters of a function within the source code.

In some embodiments, generating the code string based on the representation of portions of the source code may involve concatenating the portions of the source code into the code string.

In some embodiments, concatenating the portions of the source code into the code string may involve traversing the representation of portions of the source code in a depth-first or breadth-first order, and appending the portions to the code string in the order of the traversal.

In some embodiments, determining that the portions of the source code satisfy the change condition may involve determining that the previous hash digest exists in a hash table that associates the portions of the source code with a hash digest entry for the previous hash digest, determining the hash digest matches the previous hash digest, and in response to determining that the hash digest matches the previous hash digest, overwriting the previous hash digest in the hash digest entry with the hash digest.

In some embodiments, determining that the portions of the source code satisfy the change condition may involve determining that the previous hash digest does not exist in a hash table that associates the portions of the source code with a hash digest entry for the previous hash digest, and in response to determining that the previous hash digest does not exist in the hash table, inserting the hash digest into the hash digest entry.

In some embodiments, determining that the hash digest does not exist in the hash table may involve determining that the previous hash digest entry is blank, empty, or null.

In some embodiments, the representation of portions of the source code may involve a syntax tree, wherein the syntax tree comprises nodes and links, wherein the nodes represent distinct units of the source code, and wherein links represent references and dependencies within the code between respective nodes.

In some embodiments, the syntax tree may be constructed through identifying scoped variable identifiers within the portions of the source code, wherein a scoped variable identifier is a specific part of the source code that is not at a top level of the source code, and is a declaration or link to a declaration of a specific variable or function within the source code.

In some embodiments, the nodes of the syntax tree may relate to scoped variable identifiers, import statements, functions, and variables within the portions of the source code.

In some embodiments, updating the portions of the source code may involve rebuilding the portions of the source code.

In some embodiments, rebuilding the portions of the source code may involve compiling the portions of the source code to execute on a target platform.

In some embodiments, obtaining the representation of portions of the source code may occur in response to writing the source code to non-volatile memory.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a representation of portions of source code, wherein the portions of the source code are associated with a component of a software application;
generating a code string based on the representation of portions of the source code;
generating a hash digest based upon the code string;
determining, based on the hash digest and a previous hash digest, that the portions of the source code satisfy a change condition; and
in response to determining that the change condition is satisfied, updating the component of the software application in relation to the portions of the source code.

2. The method of claim 1, further comprising:
obtaining a further representation of further portions of the source code, wherein the further portions of the source code are associated with a further component of the software application;
generating a further code string based on the further representation of the further portions of the source code;
generating a further hash digest based upon the further code string;
determining, based on the further hash digest and a further previous hash digest, that the further portions of the source code satisfy the change condition; and
in response to determining that the change condition is satisfied, updating the further component of the software application in relation to the further portions of the source code.

3. The method of claim 1, further comprising:
obtaining a further representation of further portions of the source code, wherein the further portions of the source code are associated with a further component of the software application;
generating a further code string based on the further representation of the further portions of the source code;
generating a further hash digest based upon the further code string;
determining, based on the further hash digest and a further previous hash digest, that the further portions of the source code do not satisfy the change condition; and
in response to determining that the change condition is not satisfied, refraining from updating the further component of the software application in relation to the further portions of the source code.

4. The method of claim 1, wherein the source code contains further portions that are not associated with the component, and wherein any components of the software application related to the further portions are not updated in response to determining that the change condition is satisfied.

5. The method of claim 1, wherein the portions of the source code are within one of a plurality of predefined portions of the source code, wherein obtaining the representation of the portions of the source code comprises:
selecting, from a set of indicators relating to the predefined portions of the source code, a specific indicator associated with the portions of the source code; and
based on the specific indicator, parsing the source code to find the portions of the source code.

6. The method of claim 5, wherein the indicators are parameters of a function within the source code.

7. The method of claim 1, wherein generating the code string based on the representation of portions of the source code comprises concatenating the portions of the source code into the code string.

8. The method of claim 7, wherein concatenating the portions of the source code into the code string comprises:
traversing the representation of portions of the source code in a depth-first or breadth-first order; and
appending the portions to the code string in the order of the traversal.

9. The method of claim 1, wherein determining that the portions of the source code satisfy the change condition comprises:
determining that the previous hash digest exists in a hash table that associates the portions of the source code with a hash digest entry for the previous hash digest;
determining the hash digest matches the previous hash digest; and
in response to determining that the hash digest matches the previous hash digest, overwriting the previous hash digest in the hash digest entry with the hash digest.

10. The method of claim 1, wherein determining that the portions of the source code satisfy the change condition comprises:
determining that the previous hash digest does not exist in a hash table that associates the portions of the source code with a hash digest entry for the previous hash digest; and
in response to determining that the previous hash digest does not exist in the hash table, inserting the hash digest into the hash digest entry.

11. The method of claim 10, wherein determining that the hash digest does not exist in the hash table comprises determining that the previous hash digest entry is blank, empty, or null.

12. The method of claim 1, wherein the representation of portions of the source code comprises a syntax tree, wherein the syntax tree comprises nodes and links, wherein the nodes represent distinct units of the source code, and wherein links represent references and dependencies within the code between respective nodes.

13. The method of claim 12, wherein the syntax tree is constructed through identifying scoped variable identifiers within the portions of the source code, wherein a scoped variable identifier is a specific part of the source code that is not at a top level of the source code, and is a declaration or link to a declaration of a specific variable or function within the source code.

14. The method of claim 13, wherein the nodes relate to scoped variable identifiers, import statements, functions, and variables within the portions of the source code.

15. The method of claim 1, wherein updating the component of the software application in relation to portions of the source code comprises rebuilding the component of the software application in relation to portions of the source code.

16. The method of claim 15, wherein rebuilding the component of the software application in relation to portions of the source code comprises compiling the component of the software application in relation to portions of the source code to execute on a target platform.

17. The method of claim 1, wherein the software application is a web application that is configured to execute at least in part on a client device and to communicate with a server device.

18. The method of claim 1, wherein obtaining the representation of portions of the source code occurs in response to writing the source code to non-volatile memory.

19. A computing system comprising:
one or more processors;
memory; and
program instructions, stored in the memory, that upon execution by the one or more processors cause the computing system to perform operations comprising:
obtaining a representation of portions of source code, wherein the portions of the source code are associated with a component of a software application;
generating a code string based on the representation of portions of the source code;
generating a hash digest based upon the code string;
determining, based on the hash digest and a previous hash digest, that the portions of the source code satisfy a change condition; and
in response to determining that the change condition is satisfied, updating the component of the software application in relation to the portions of the source code.

20. A non-transitory computer-readable medium storing program instructions that, when executed by one or more processors of a computing system, cause the computing system to perform operations comprising:
obtaining a representation of portions of source code, wherein the portions of the source code are associated with a component of a software application;
generating a code string based on the representation of portions of the source code;
generating a hash digest based upon the code string;
determining, based on the hash digest and a previous hash digest, that the portions of the source code satisfy a change condition; and
in response to determining that the change condition is satisfied, updating the component of the software application in relation to the portions of the source code.
